(19) United States
(12) Patent Application Publication
(10) Pub. No.: US 2022/0237586 A1
(43) Pub. Date: Jul. 28, 2022

(54) SYSTEMS AND METHODS FOR PROCESSSING PAYMENTS SECURELY

(71) Applicant: Yevma, Inc., Newark, DE (US)

(72) Inventor: Evraam Gorgy, Onalaska, WI (US)

(73) Assignee: Yevma, Inc., Newark, DE (US)

(21) Appl. No.: 17/337,103

(22) Filed: Jun. 2, 2021

Related U.S. Application Data
(63) Continuation-in-part of application No. 16/783,197, filed on Feb. 6, 2020, now abandoned.
(60) Provisional application No. 62/835,518, filed on Apr. 18, 2019.

(51) Int. Cl. G06Q 20/32; G06Q 20/02; G06Q 20/40

(52) U.S. Cl. CPC G06Q 20/3255; G06Q 20/4012; G06Q 20/027

(57) ABSTRACT

The present disclosure comprises a system that processes mobile fund transfer or payments in lesser time utilizing Short Message Service (SMS) and without involving third party fund transfer applications to be actively downloaded by the user on his or her smartphone, tablet, etc. The payor and the payee process fund transfer in lesser time and securely through mobile phone's SMS service.

### CROSS-REFERENCE TO RELATED APPLICATION

This application is a continuation-in-part and claims priority to U.S. patent application Ser. No. 16/783,197 entitled System and Method for Processing Payments Securely and filed on Feb. 6, 2020, which claims priority to U.S. Provisional Patent Application No. 62/835,518 filed on Apr. 18, 2019, both of which are incorporated by reference.

### FIELD OF THE DISCLOSURE

This invention relates to a system and method for processing payments efficiently and securely over SMS (Short Message Service).

Any discussion of documents, acts, materials, devices, articles or the like which has been included in this specification is solely for the purpose of providing a context for the present invention. It is not to be taken as an admission that any or all these matters form a part of the prior art base or were common general knowledge in the field relevant to the present invention as it existed in the United States of America or elsewhere before the priority date of this application.

Fund transfer is an integral part of our day to day life. There are several fund transfer applications which work solely upon downloading third party applications including merchant application, bank, and credit card applications etc. There are further applications like Mobile Wallet that stores credit cards, debit cards and rewards information on a mobile device. Likewise, there are several other applications that uses mobile technology of the smartphones and tablets for online transactions. Applications like Mobile Wallet uses near field communication (NFC) which uses radio frequencies to communicate between devices. Once the mobile wallet application is installed, the wallet stores the credit card, debit card and rewards information by linking a personal identification format for example a key, a QR Code or owner's image.

While the abovementioned methods of fund transfer are reliable but predominantly rely upon active internet connection. Moreover, the third-party software applications occupy a certain disk space and bandwidth of user's smartphone device. On the other hand, the present invention utilizes Short Message Service (SMS) to process mobile payments efficiently and instantly without the need of active internet connection at the user's end.

It is an object of the present disclosure to overcome, or substantially ameliorate, one or more of the disadvantages of the prior art, or to provide an efficient alternative to fund transfer.

It is yet another object of the present disclosure to process mobile fund transfer or payments in lesser time utilizing Short Message Service (SMS) without involving third party fund transfer applications to be actively downloaded by the user on his or her smartphone, tablet, etc.

It is yet another object of present disclosure to utilize Short Message Service (SMS) to approve fund transfer without the need of active internet connection or third party fund transfer applications. The payor and the payee processes fund transfer in lesser time and securely and solely through mobile phone's SMS service.

It is yet another object of present disclosure wherein the system urges the payor to use PIN, fingerprint, or face ID to send or receive SMS to approve fund transfer to the payee. The payee may be an individual or a merchant who may use the present disclosure to securely and efficiently process payments and frequently reward customers and offer promotions, similarly various embodiments of the present system and method may be possible within the realms of present invention without limiting the scope of present invention.

It is yet another object of the present disclosure to develop a system and method to transfer funds solely through Short Message Service (SMS) of the mobile carrier without actively involving the internet connectivity at any stage of the fund transfer either at the payor's or payee's end.

The features and advantages of the present disclosure will become further apparent from the following detailed description, provided by way of example only, together with the accompanying drawings.

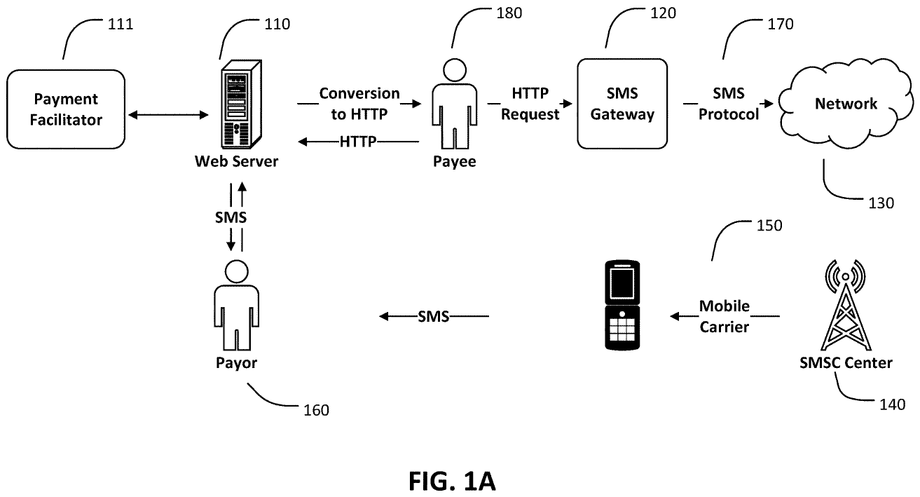

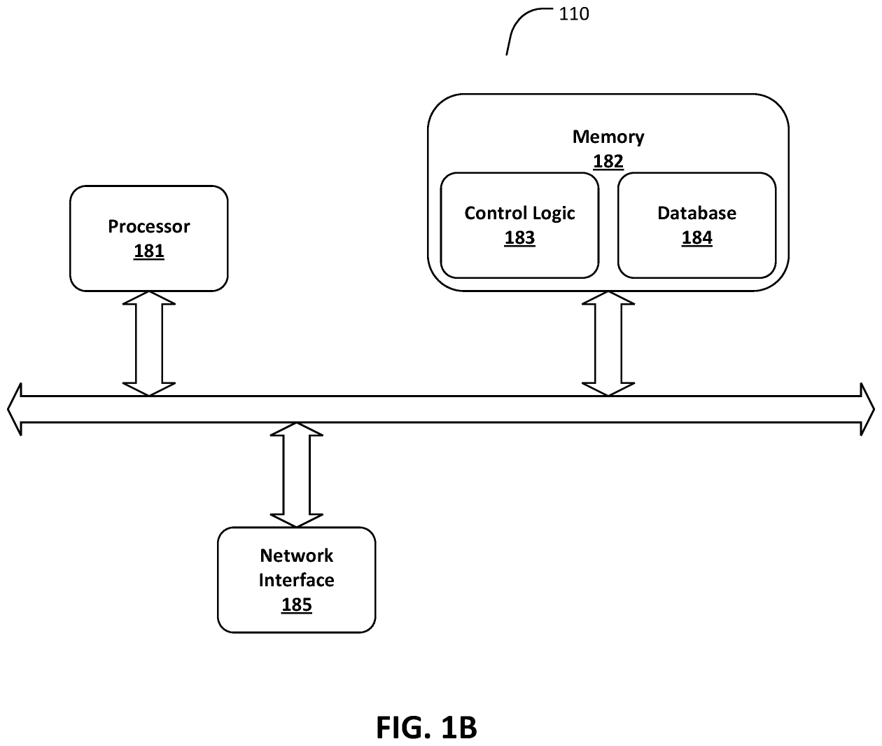

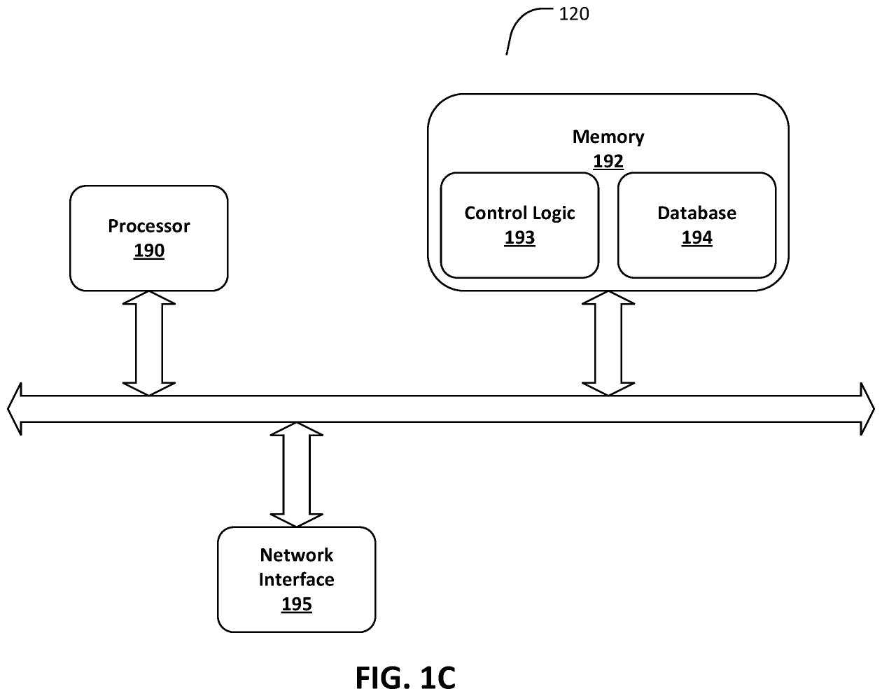

FIG. 1A is a diagram for transferring of funds through SMS according to an embodiment of the present invention.

FIG. 1B is a block diagram of a webserver such as is shown in FIG. 1.

FIG. 1C is a block diagram of a short message service (SMS) gateway such as is shown in FIG. 1A.

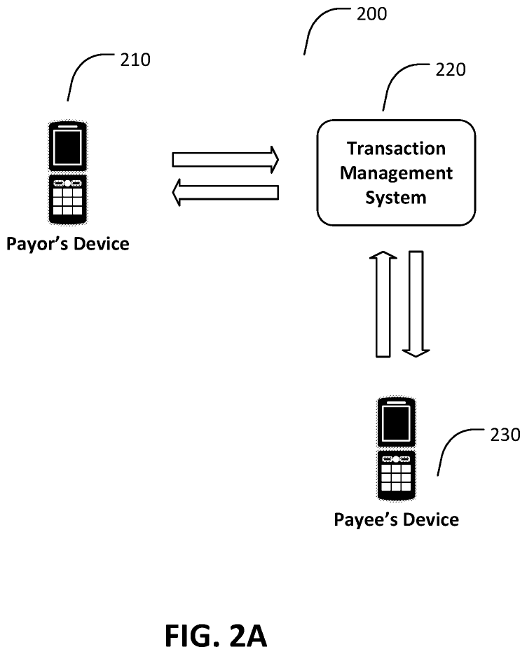

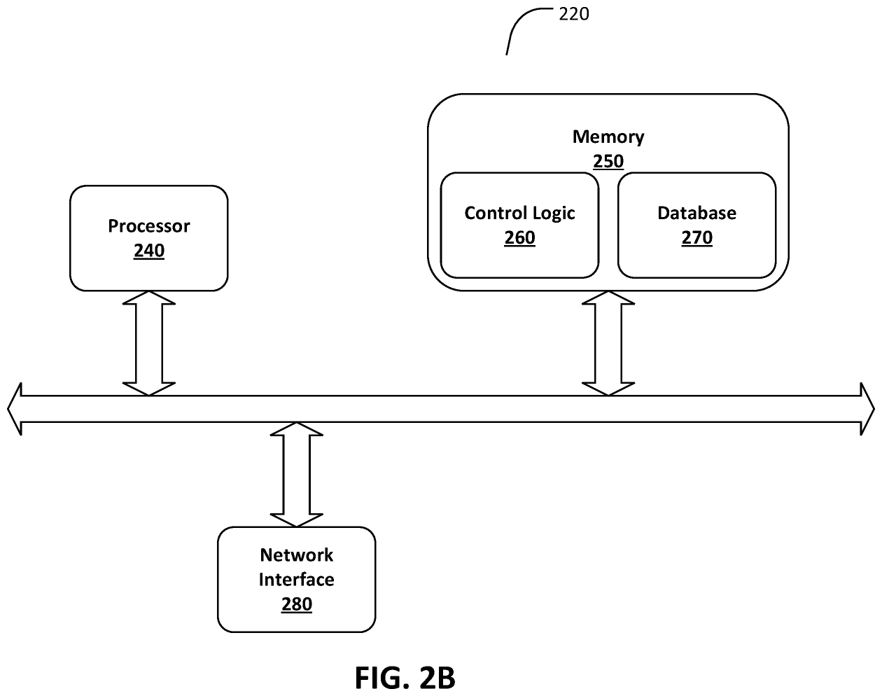

FIG. 2A is a block diagram for transaction of funds using the system such is as shown in FIG. 1.

FIG. 2B is a block diagram of a transaction management system such is as shown in FIG. 2A.

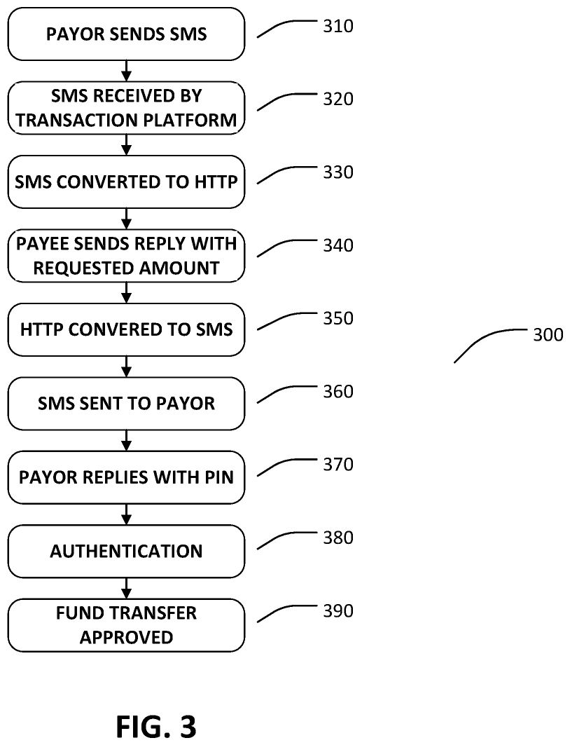

FIG. 3 is a flowchart depicting the process of fund transfer through SMS according to an embodiment of the present invention such is as used in the system shown in FIG. 1.

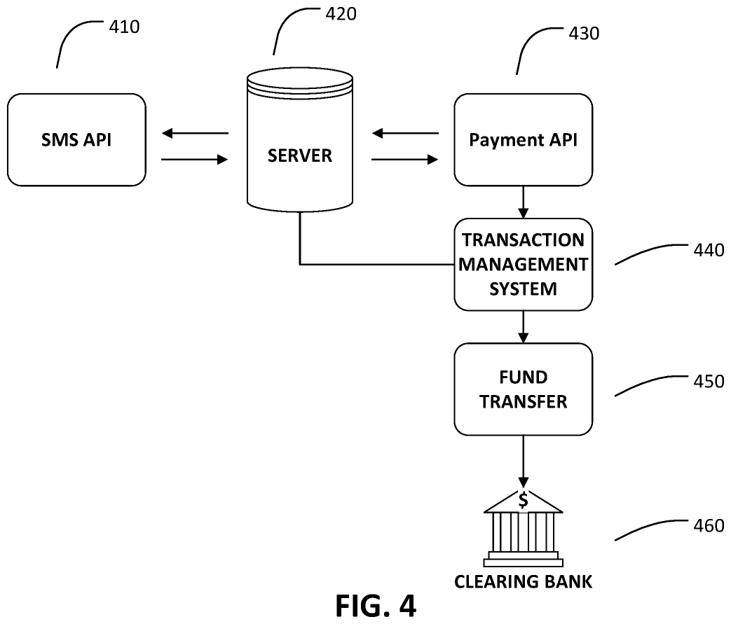

FIG. 4 is a block diagram of the transaction process according to an embodiment of the present invention that includes a banking institution of the system such as is shown in FIG. 1.

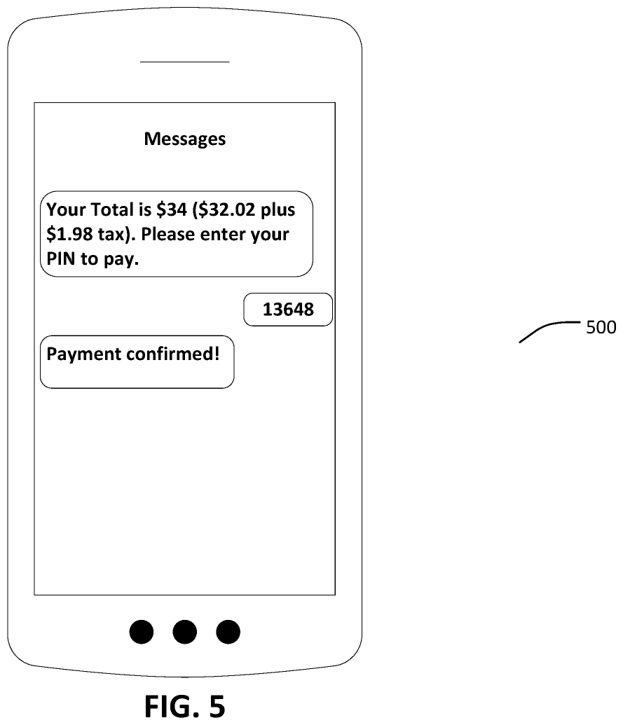

FIG. 5 is an exemplary graphical user interface in accordance with an embodiment of the present disclosure such is as used in the system of FIG. 1.

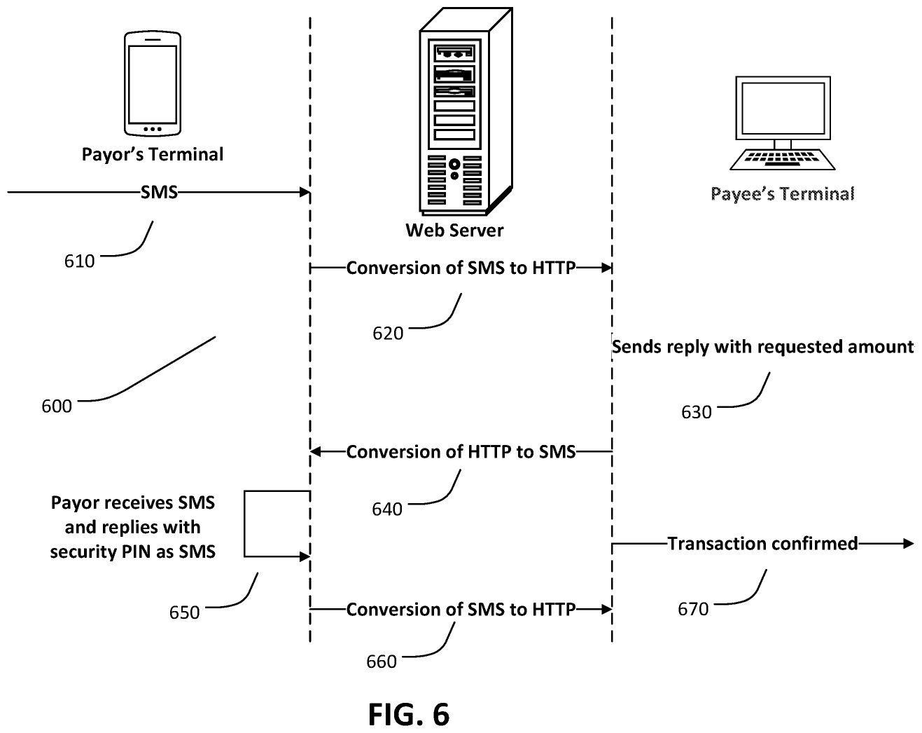

FIG. 6 is a flowchart depicting fund transfer from a payor's terminal to a payee's terminal through short message service (SMS) using the cellular network using the system such as is shown in FIG. 1.

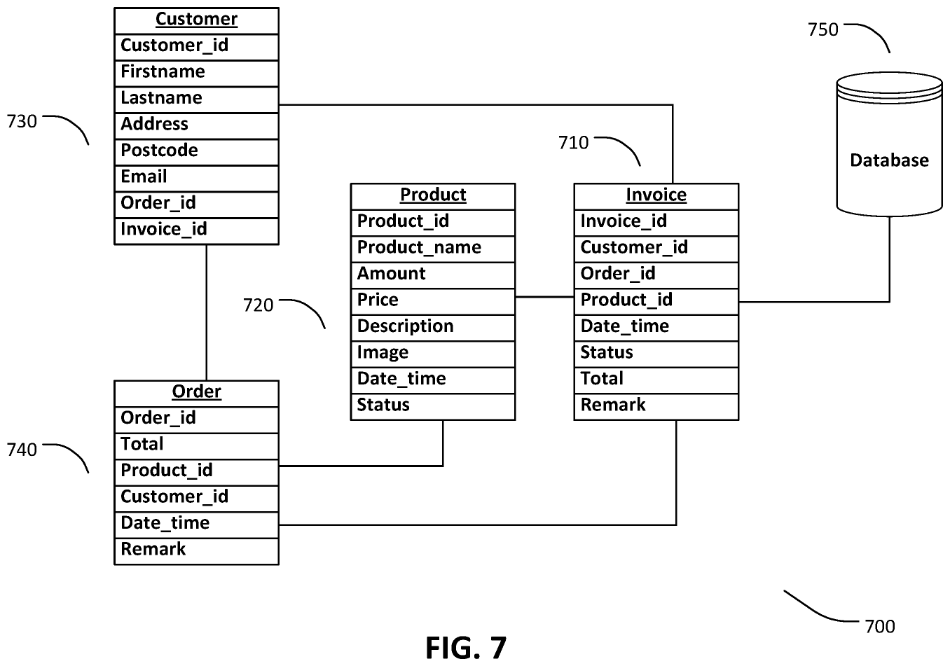

FIG. 7 is a flowchart of an exemplary process of a database of the system shown in FIG. 1.

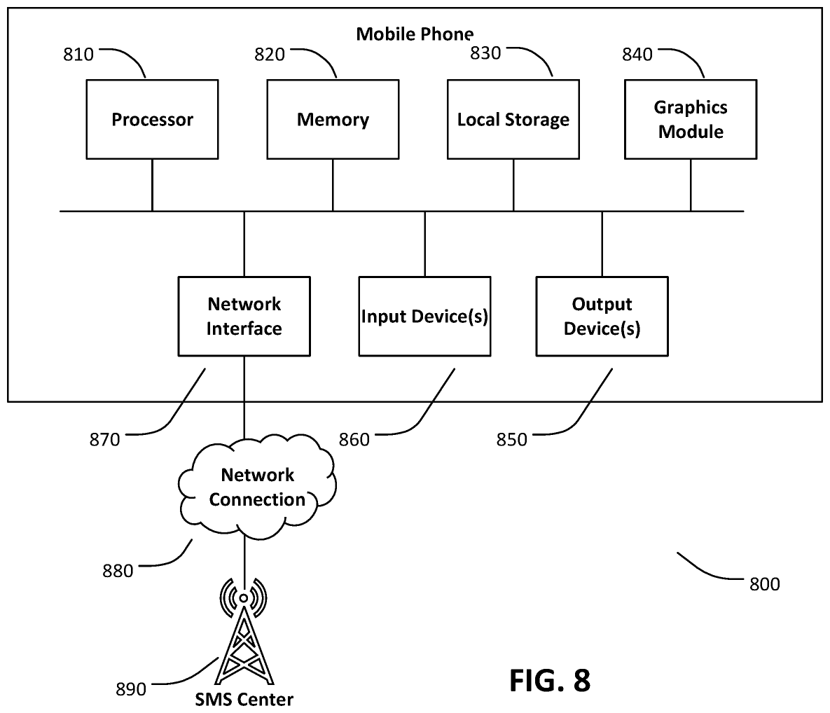

FIG. 8 is a block diagram of an exemplary mobile device such as is used in the system of FIG. 1.

### DETAILED DESCRIPTION

FIG. 1A is a block diagram showing a system 100 for the transfer of funds through SMS (Short Message Service) in accordance with an embodiment of the present disclosure. The system includes a webserver 110, an SMS gateway 120, a network 130 a SMS center 140, and a handheld devices 121 and 122. The system 100 enables payors to pay for goods and services via SMS, which is described herein.

To purchase the goods and services, a Payor must pay for the goods and services. To effectuate a payment, a Payor 160 sends a SMS message to the webserver 110. Note that in one embodiment, the Payor 160 sends a SMS message using the computing device 122, e.g., a cell phone, a tablet, or a laptop. The SMS transmitted by the Payor 160 comprises data that indicates that the Payor 160 desires to purchase goods and/or services.

Upon receipt of the SMS from the Payor 160, the webserver 110 stores data indicative of details about the SMS, e.g., time of message, the Payor's details, payee's number etc., which is stored in a database (shown in FIG. 7). Note that Payor's details may include, for example, the Payor's address, phone number and payment information, i.e., credit card, debit card or bank account information.

Further, the webserver translates the SMS into hypertext transfer protocol (HTTP). The translation allows the message to be transmitted over a network, e.g., network 130. In this regard, HTTP is a TCP/IP based communication protocol, that is used to deliver data (HTML files, image files, query results. etc.) on the World Wide Web. Thus, if one wishes to transfer data over the World Wide Web, one must transfer data formatted as HTTP.

After translation has been done, the webserver transmits data indicative of a notification to the Payee 180 that a transaction has been initiated via the SMS gateway 120, the SMS center 140, and the Payee's computing device 121. In this regard, the Payee 180 may receive this notification via his/her computing device. Once the Payee 180 has been notified of a pending transaction, the Payee 180 sends a reply through the SMSC center 140, the network 130, the SMS gateway 120 and the Payee's computing device 121 to the webserver 110 in HTTP format. In one embodiment, the reply contains at least the requested invoice amount.

The webserver 110 further converts the HTTP message (the invoice amount to data indicative of an SMS and sends an SMS to the payor's computing device 122 the data indicative of the SMS, which contains the invoice amount. This protocol conversion for the request coming from webserver 110 is generally in the form of HTTP (Hyper Text Transfer Protocol). Thus, the HTTP message effectively cross links and navigates various nodes of the webspace.

The SMS gateway 120 acts as a bridge between SMS and HTTP network formats. In this regard, the SMS gateway 120 receives data indicative of an HTTP request from the Payee's computing device 121, translates the data to an SMS, and transmits the SMS, which contains data indicative of the message. That is, if the SMS is from the payor 160, the SMS may contain data indicative of a request for goods and/or services, or if the SMS is from the Payee 180, the SMS may contain data indicative of an invoice for the goods and/or services requested.

Furthermore, the SMS gateway communicates with SMS Centre (SMSC) 140 through SMS protocol 170 over network 130. Most of these SMS protocols or SMSC protocols are proprietary to the mobile carrier 150 or service provider. The SMS Centre 140 stores the messages sent by the payor 160 and delivers to the intended Payee 180 via the Payee's computing device 121.

FIG. 1B is a block diagram of an exemplary webserver such as is shown in FIG. 1A. As shown by FIG. 1B, the webserver 110 comprises a processor 181, a network interface 185, webserver control logic 183, a database 184, and memory 182. Stored in memory 182 is webserver control logic 183 for receiving messages and sending message. The Network interface 185 allows webserver 110 to communicate with the various components of the system 100.

The exemplary embodiment of the webserver 110 depicted by FIG. 1B comprises at least one conventional processing element 181, such as a Digital Signal Processor (DSP) or a Central Processing Unit (CPU), that communicates to and drives the other elements within the webserver 110 via a local interface 186, which can include at least one bus. Further, the processing element 181 is configured to execute instructions of software, such as webserver control logic 183.

The webserver control logic 183 generally controls the functionality of the webserver 110, as will be described in more detail hereafter. It should be noted that the webserver control logic 183 can be implemented in software, hardware, firmware, or any combination thereof. In an exemplary embodiment illustrated in FIG. 1B, the webserver control logic 183 is implemented in software and stored in memory 182.

Note that the webserver control logic 183, when implemented in software, is stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

Also stored in memory 182 is a database 184. The database retains all information related to payees, payors, and transactions. The database 184 is described further with reference to FIG. 7.

Further, the network interface 185 is configured to enable the webserver 110 to communicate over a network, e.g., 130. The network interface 185 enables the system 100 to send and receive SMS messages from the payee and the payor.

FIG. 1C is a block diagram of a short message service (SMS) gateway such as is shown in FIG. 1A. As shown by FIG. 1C, the SMS gateway 120 comprises a processor 190, a network interface 195, SMS gateway control logic 193, and memory 192. Stored in memory 192 is SMS gateway control logic 193 for receiving HTTP messages, translating the messages to SMS, and sending the messages to the payee or payor. The Network interface 195 allows SMS gateway 120 to communicate with the various components of the system 100.

The exemplary embodiment of the SMS gateway depicted in FIG. 1C comprises at least one conventional processing element 190, such as a Digital Signal Processor (DSP) or a Central Processing Unit (CPU), that communicates to and drives the other elements within the SMS gateway 120 via a local interface 196, which can include at least one bus. Further, the processing element 190 is configured to execute instructions of software, such as SMS gateway control logic 193.

The SMS gateway control logic 193 generally controls the functionality of the SMS gateway 120, as will be described in more detail hereafter. It should be noted that the SMS gateway control logic 193 can be implemented in software, hardware, firmware, or any combination thereof. In an exemplary embodiment illustrated in FIG. 1C, the SMS gateway control logic 193 is implemented in software and stored in memory 192.

Note that the SMS gateway control logic 193, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

Further, the network interface 195 is configured to enable the SMS gateway 120 to communicate over a network, e.g., 130. The network interface 195 enables the system 100 to send and receive SMS messages from the payee and the payor.

FIG. 2A is a block diagram 200 for transaction of funds according to an embodiment of the present disclosure. Payor's handheld device, laptop, or tablet 210, for example, communicates with the transaction management system 220 of the present disclosure by the way of SMS (Short Service Message). That is, when a Payor 160 (FIG. 1) decides to purchase goods or services or to merely make a payment on a bill, the Payor 160, using his/her handheld device 210, for example, cell phone, laptop, or tablet, the Payor 160 initiates an SMS that is transmitted to the transaction management system 220.

Similarly, the payee's handheld device 230, for example, cell phone, tablet, or laptop 230 interacts with the transaction management system 220 of the present disclosure by the way of SMS (Short Service Message). The process will become clearer by the way of embodiments described below.

In one embodiment, the transaction management system 220 is a server. In this regard, the transaction management system 220 comprises at least a processor, memory, and control logic store in the memory, described with reference to FIG. 2B. The processor is configured to execute the instructions contained in the transaction management system control logic. The control logic may be hardware, software, firmware, or any combination thereof.

FIG. 2B is a block diagram of an exemplary transaction management system 220 such as is shown in FIG. 2A. As shown by FIG. 2B, the transaction management system 220 comprises a processor 240, a network interface 280, transaction management control logic 260, and memory 270. Stored in memory 182 is webserver control logic 183 for receiving messages and sending message. The Network interface 185 allows webserver 110 to communicate with the various components of the system 100.

The exemplary embodiment of the transaction management system 220 depicted by FIG. 2B comprises at least one conventional processing element 240, such as a Digital Signal Processor (DSP) or a Central Processing Unit (CPU), that communicates to and drives the other elements within the transaction management system 220 via a local interface 290, which can include at least one bus. Further, the processing element 240 is configured to execute instructions of software, such as transaction management control logic 260.

The transaction management control logic 260 generally controls the functionality of the transaction management system 220, as will be described in more detail hereafter. It should be noted that the transaction management control logic 260 can be implemented in software, hardware, firmware, or any combination thereof. In an exemplary embodiment illustrated in FIG. 2B, the transaction management control logic 260 is implemented in software and stored in memory 250.

Note that the transaction management control logic 260, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

Further, the network interface 280 is configured to enable the transaction management system 220 to communicate over a network, e.g., 130. The network interface 280 enables the system 100 to send and receive SMS messages from the payee and the payor.

FIG. 3 is a flowchart 300 of the architecture and functionality of the system shown in FIG. 1. At step 310 the Payor 160 (FIG. 1) sends data indicative of short message service (SMS) to the transaction management system 220 (FIG. 2).

The data indicative of the payor's SMS is received by the transaction management system 220 at step 320. The transaction management system 220 converts the received SMS to HTTP (Hyper Text Transfer Protocol) at step 330. Notably, the protocol conversion is performed because the request coming from webserver is generally in the form of HTTP (Hyper Text Transfer Protocol), which effectively cross links and navigates various nodes of the Internet.

At step 340, the Payee 180 sends a reply with the cost of the goods or services in HTTP format to the transaction management system 220. At step 350, the HTTP request is converted to SMS by the transaction management system 220 before sending an approval via SMS to the Payor 160.

At step 360, data indicative of an SMS request with fund transfer approval is sent to the Payor 160 by the transaction management system 220. Upon receiving the SMS request, the Payor 160 replies an SMS comprising data indicative of the Payor's security PIN (which the Payor 160 obtained during initial registration with the transaction management system 220) for the approval of a fund transfer. At step 380, the transaction identifier (ID), personal identification number (PIN) and phone numbers of the Payor 160 and Payee 180 are authenticated by the transaction management system 220 using data stored when the Payee 160 and Payor 180 signed up for the services of the transaction management system 220. At step 390, if the Payee 160 and the Payor 180 are authenticated, the fund transfer is approved.

FIG. 4 is a block diagram of a transaction process according to an embodiment of the present disclosure. The system in FIG. 4 comprises a short message service (SMS) application programming interface (API), a server 420, a payment API 430, a transaction management system 440, and a clearing bank 460.

The short message service (SMS) Application Programming Interface (API) communicates with the server 420. In this regard, the SMS API 410 transmits data indicative of a request to purchase goods or services in an SMS to the server 420.

The server is a computing device that comprises a processor, memory, and control logic stored in the memory. The server 420 interacts with the transaction management system 440 to facilitate fund transfer to the Payee 180 (FIG. 1).

The payment API 430 communicates with the server 420 to facilitate fund transfer. Notably, the transaction management system 440 approves fund transfer to the Payee 180. The funds are transferred from the Payor 160 (FIG. 1) to the clearing bank 460. The Payor 180 may access his/her funds at the clearing bank 460.

FIG. 5 is a diagram describing the process of fund transfer from payor's account to payee's account through SMS using a predefined security pin set by Payor (180).

The graphical user interface (GUI) 500, enables the fund transfer process using SMS. In this regard, the Payee 160 (FIG. 1) receives a bill or invoice via SMS. In response to receiving the bill or invoice, as shown, the Payee 160 replies with their security PIN (13648 in the example provided) to complete the transaction.

FIG. 6 illustrates an exemplary embodiment of the system 600 depicting the process of fund transfer from the payor's terminal to the payee's terminal through SMS using the cellular network. A SMS is transmitted by Payor 180 to the webserver 610. The webserver converts the SMS received into HTTP 620 to notify payee's transaction initiation.

Payee 108 then replies to the webserver with the requested amount 630. The webserver receives the replay in HTTP format; therefore, the webserver converts the HTTP message to SMS 640. The webserver transmits the converted SMS to the Payor 180.

Upon receipts, the graphical user interface (GUI) may appear on the Payor's phone. The Payor 160 receives the SMS and replies with a security pin as SMS 650 for the approval of fund transfer. Note that the security PIN may be provided to the Payor 160 when the Payor 160 signs up for the service. The webserver coverts the SMS message provided by the Payor 160 to HTTP 660. The webserver transmits data indicative of transaction IDs, PINs, and Phone numbers of the Payor 160 and Payee 180 and the payor and payee are authenticated by the transaction management system 220 (FIG. 2) and the fund transfer is approved, if data received reconciles with the database 184 (FIG. 1B).

FIG. 7 illustrates a flowchart 700 of the database 184 of the system containing data of the customer (Payor 160), product, order, and invoice. The system uses invoice table 710 along with customer table 730, product table 720 and order table 740 for generation of the invoice and transaction authentication.

FIG. 8 illustrates a system 800 for implementing the present disclosure. The System 800, e.g., a mobile phone, a processor 810 and memory 820. Processor 810 is configured to execute program instructions. The processor may be a real processor in one embodiment but a virtual processor in another embodiment.

It will be understood that the computing system 800 does not suggest any limitation as to the scope of use or functionality of described embodiments. The computing system 800 may include, but is not limited to, one or more of the general purpose computer, a programmed microprocessor, a microcontroller, an integrated circuit, and other devices or arrangements of devices that implement the steps that constitute the method of the present disclosure.

Exemplary embodiments of a computing system 800 in accordance with the present disclosure may include one or more servers, desktops, laptops, tablets, smartphones, mobile phones, mobile communication devices, tablets, phablets, and personal digital assistants. In an embodiment of the present invention, the memory 820 may store instructions for implementing various embodiments of the present invention.

The local storage 830 may include any types of computer memory, magnetic stripes, smart cards, printed barcodes or any other transitory or non-transitory medium which may be used to store information and can be accessed by the computing system.

The input device(s) 860 may include, but is not limited to, a touch screen, a keyboard, mouse, pen, joystick, trackball, a voice device, a scanning device, or any other device that can provide input to the computing system. In an embodiment of the present invention, the input device(s) 860 may be a sound card or similar device that accepts audio input in analog or digital form.

The output device(s) 850 may include, but not be limited to a user interface on CRT, LCD, LED display, or any other display associated with any of ervers, desktops, laptops, tablets, smartphones, mobile phones, mobile communication devices, tablets, phablets and personal digital assistants, printer, speaker, CD/DVD writer, or any other device that provides output from the computer system. In various embodiments of the present invention, the storage 830 may contain program instructions for implementing any of the above-described embodiments. In an embodiment of the present invention, the computer system is part of a distributed network or a part of a set of available cloud resources. The method described in the present invention comprises a set of program instructions that are executed by the computing system or any other similar device. The set of program instructions may be a series of computer-readable codes stored on a tangible medium, such as a computer-readable storage medium (storage 830).

The graphic module 840 includes graphic card for displaying interactive content on the screen. In an embodiment of the present invention, the network interface may include an ethernet card or other network interface controller that connects the device to the network 880 which in turn is connected to the SMS center 890.

While several devices and variations thereof have been described, it will be appreciated by persons skilled in the art that numerous variations and/or modifications may be made to the invention without departing from the spirit or scope of the invention as broadly described. The specification uses words “device” and “phone” interchangeably. The present embodiments are, therefore, to be considered in all respects as illustrative and not restrictive.

1. A system for facilitating transfer of funds from payor's account to payee's account comprising:
a payor's computing device;
a payee's computing device;
a first processor configured for converting short message service (SMS) messages to hypertext transfer protocol (HTTP) and configured for converting HTTP messages to SMS protocol, the processor further configured for receiving a first SMS message and converting the first SMS message to HTTP, the processor further configured to transmit a second SMS message to the payor's computing device, the second SMS message comprising data indicative of an invoice or an amount of money to be paid.

2. The system of claim 1, further comprising an SMS gateway that comprises a processor, the processor configured to translate an HTTP request to an SMS request.

3. The system of claim 2, further comprising a second processor, the processor configured to transmit the SMS request over a network to the payor's computing device, the message containing the invoice or the amount of money to be paid.

4. The system of claim 1, wherein the payee's computing device transmits an HTTP message, and the processor is further configured to translate the HTTP message to and SMS message and transmit the SMS message to the payor's computing device.

5. The system of claim 4, where the SMS message transmitted to the payor's computing device comprises data indicative of the invoice or the amount of money to be paid.

6. The system of claim 1, further comprising and SMS application program interface (API) that communicates with a server.

7. The system of claim 6, wherein the SMS API transmits a request to purchase goods or services in SMS protocol to a payment API.

8. The system of claim 7, wherein the payment API transmits data indicative of the request to a transaction management system.

9. The system of claim 8, wherein the transaction management system approves or disapproves the transaction.

10. The system of claim 9, wherein the transaction management system initiates a transfer of funds from payor's account to payee's account.

11. A method for transferring funds from payor's account to payee's account comprising the steps of:
a.) sending an invoice request or a bill request via payor's computing device to a server, wherein the request is in short message service (SMS) format;
b.) Converting, by the server, the invoice request or bill request from SMS format to hypertext transfer protocol (HTTP) format;
c.) responding to the HTTP request at the payee's computing device by sending an HTTP message to the server;
d.) converting the HTTP message into an SMS message;
e.) receiving the SMS message at the payor's computing device by the payor;
f.) responding, via the payor's computing device, with a security pin through SMS;
e.) authenticating transaction identifier (ID), personal identification number (PIN) and phone numbers of the payor and payee by the transaction management system.
approving the fund transfer by a clearing bank

12. A method for transferring funds from payor's account to payee's account, according to claim 11 wherein, an SMS Application Programming Interface (API) communicates with the server

13. A method for transferring funds from payor's account to payee's account, according to claim 12 wherein, the server interacts with the transaction management system to facilitate fund transfer process to the payee.

14. A method for transferring funds from payor's account to payee's account, according to claim 13 wherein, the payment API communicates with the server to facilitate fund transfer.

15. A method for transferring funds from payor's account to payee's account, according to claim 14 wherein, the transaction management system approves fund transfer to the payee.

16. A method for transferring funds from payor's account to payee's account according to claim 15, wherein the funds transferred from the payor is transferred to the payee by the clearing bank.

17. A method for transferring funds from payor's account to payee's account according to claim 11 wherein, the process of fund transfer from payor's account to payee's account through SMS uses a predefined security pin set by payor.

18. A method for transferring funds from payor's account to payee's account according to claim 17 wherein, the payor receives the bill or invoice via SMS and replies with their security personal identification number (PIN) to complete the transaction.

19. A transaction management system for facilitating transfer of funds from payor's account to payee's account according to claim 1, wherein the SMS Centre stores the messages sent by the payor and delivers to the intended payee.

20. A transaction management system for facilitating transfer of funds from payor's account to payee's account wherein, the system uses an invoice table a customer table, a product table, and an order table for generation of the invoice and transaction authentication.

21. A transaction management system for facilitating transfer of funds from payor's account to payee's account according to claim 1, wherein the payor to use PIN, fingerprint, or face ID to send or receive SMS to approve fund transfer to the payee.

22. A transaction management system for facilitating transfer of funds from payor's account to payee's account according to claim 21, wherein the payee is an individual or a merchant who uses the system securely and efficiently processes payments and frequently rewards customers and offer promotions.

23. A transaction management system for facilitating transfer of funds from payor's account to payee's account according to claim 22, wherein the system transfer funds through Short Message Service (SMS) of the mobile carrier without actively involving the internet connectivity at any stage of the fund transfer by the payor or the payee.
